(19) United States
(12) Patent Application Publication
(10) Pub. No.: US 2026/0179839 A1
(43) Pub. Date: Jun. 25, 2026

(54) CERAMIC ELECTRONIC COMPONENT

(71) Applicant: SAMSUNG ELECTRO-MECHANICS CO., LTD., Suwon-si (KR)

(72) Inventors: Hyoung Uk KIM, Suwon-si (KR); Seon Ho KIM, Suwon-si (KR); Si Taek PARK, Suwon-si (KR); Yoon Soo PARK, Suwon-si (KR); Seok Hyun YOON, Suwon-si (KR); Jeong Yun PARK, Suwon-si (KR); Tae Young HAM, Suwon-si (KR); Hye Won RYOO, Suwon-si (KR); Hyung Soon KWON, Suwon-si (KR); No Hun BAK, Suwon-si (KR)

(73) Assignee: SAMSUNG ELECTRO-MECHANICS CO., LTD., Suwon-si (KR)

(21) Appl. No.: 19/337,554

(22) Filed: Sep. 23, 2025

(30) Foreign Application Priority Data
Dec. 24, 2024 (KR) 10-2024-0195092

(51) Int. Cl. H01G 4/12; H01G 4/008; H01G 4/30

(52) U.S. Cl. CPC H01G 4/1227; H01G 4/008; H01G 4/30

(57) ABSTRACT

A ceramic electronic component is disclosed, comprising a body including a dielectric layer having a plurality of dielectric grains and an internal electrode, and an external electrode disposed on the body and connected to the internal electrode. At least one of the dielectric grains includes titanium (Ti), tin (Sn), and dysprosium (Dy), and has a core-shell structure in which a shell surrounds at least a portion of the core. The core contains less than 0.2 mol of tin (Sn) and less than 0.1 mol of dysprosium (Dy) per 100 moles of titanium (Ti). The shell includes a first region in which the amount of Sn relative to Ti is greater than the amount of Dy relative to Ti, and a second region in which the amount of Dy relative to Ti is greater than the amount of Sn relative to Ti. The ratio LC/LG of the core and grain Feret diameters is 0.49-0.73.

### CROSS-REFERENCE TO RELATED APPLICATION(S)

This application claims the benefit of priority to Korean Patent Application No. 10-2024-0195092 filed on Dec. 24, 2024 in the Korean Intellectual Property Office, the disclosure of which is incorporated herein by reference in its entirety.

### TECHNICAL FIELD

The present disclosure relates to a ceramic electronic component.

### BACKGROUND

A multilayer ceramic capacitor (MLCC), a ceramic electronic component, is a chip-type capacitor mounted on the printed circuit boards of various types of electronic products, such as video display devices such as liquid crystal displays (LCDs) and plasma display panels (PDPS), computers, smartphones and mobile phones, and onboard chargers (OBCs) and DC-DC converters for electric vehicles, to charge or discharge electricity.

As the size of various electronic components equipped with multilayer ceramic capacitors decreases and the level of integration thereof increases, the size of multilayer ceramic capacitors also needs to be reduced, and accordingly, the capacitance per unit volume needs to be improved.

A representative method for obtaining miniaturization and high capacitance of multilayer ceramic capacitors is to consider forming a thin dielectric layer, but in this case, it may be difficult to secure sufficient permittivity and reliability in harsh environments.

In the case of Korean Patent Application Publication No. 10-2022-0088099 (referred to as patent document 1), at least one of the dielectric grains of the dielectric layer has a core-double shell structure, and a method is proposed to secure high permittivity and high reliability at the same time by including at least one of Sn, Sb, Ge, Si, Ga, In, and Zr as the first element in the first shell of the double shell structure, and at least one of Ca and Sr as the second element in the second shell.

However, multilayer ceramic capacitors for general electronic devices require dielectric characteristics in which the change in capacitance is within ±15% in the temperature range of −55° C. to 85° C., and multilayer ceramic capacitors for IT products require dielectric characteristics in which the change in capacitance is within ±22% in the temperature range of −55° C. to 105° C.

In addition, such small and high-capacitance multilayer ceramic capacitors may have a tendency for capacitance thereof to decrease depending on DC bias.

Therefore, there is a need to improve a dielectric grain structure to reduce a change in capacitance due to temperature change (Temperature Coefficient of Capacitance (TCC)) and the phenomenon of capacitance changing according to DC voltage (DC-bias).

### SUMMARY

An aspect of the present disclosure is to provide a ceramic electronic component having improved TCC characteristics.

An aspect of the present disclosure is to provide a ceramic electronic component having improved DC-bias characteristics.

An aspect of the present disclosure is to provide a ceramic electronic component having an improved permittivity.

An aspect of the present disclosure is to provide a ceramic electronic component having improved high-temperature reliability.

According to an aspect of the present disclosure, a ceramic electronic component includes a body including a dielectric layer containing a plurality of dielectric grains, and an internal electrode; and an external electrode disposed on the body and connected to the internal electrode. At least one of the plurality of dielectric grains includes titanium (Ti), tin (Sn), and dysprosium (Dy), and includes a core and a shell surrounding at least a portion of the core. The core has a tin (Sn) content of less than 0.2 mol with respect to 100 moles of titanium (Ti) and a dysprosium (Dy) content of less than 0.1 mol with respect to 100 moles of titanium (Ti). The shell includes a first region in which a number of moles of tin (Sn) with respect to 100 moles of titanium (Ti) is greater than a number of moles of dysprosium (Dy) with respect to 100 moles of titanium (Ti), and a second region in which the number of moles of dysprosium (Dy) with respect to 100 moles of titanium (Ti) is greater than the number of moles of tin (Sn) with respect to 100 moles of titanium (Ti). When a maximum Feret diameter of the plurality of dielectric grains including the core and the shell is LG, and a maximum Feret diameter of the core is LC, LC/LG satisfies 0.49 or more and 0.73 or less.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a ceramic electronic component according to an embodiment;

FIG. 2 is a schematic view of a cross-sectional view taken along line I-I′ of FIG. 1;

FIG. 3 is a schematic view of a cross-sectional view taken along line II-II′ of FIG. 1;

FIG. 4 is a schematic view of dielectric grains and grain boundaries according to an embodiment;

FIGS. 5A, 5B, and 5C are images of a core-shell structure of a dielectric grain analyzed by TEM-EDX;

FIG. 6 is a schematic view of a structure of dielectric grains according to an embodiment;

FIG. 7 is a graph illustrating the results of a line-profile analysis measuring the contents of Sn and Dy along line A-A′ of FIG. 6;

FIG. 8 is a schematic view of an enlarged view of region P of FIG. 3;

FIG. 9 is a graph illustrating the results of a line-profile analysis measuring the contents of Sn and Ni along line B-B′ of FIG. 8; and

FIG. 10 is an image of the interface between a dielectric layer and an internal electrode, analyzed by TEM-EDX and an Sn element mapped.

### DETAILED DESCRIPTION

Hereinafter, embodiments will be described with reference to detailed embodiments and the attached drawings. However, the embodiments may be modified in various other forms, and the scope of the present disclosure is not limited to the embodiments described below. In addition, the embodiments are provided to more completely explain the present disclosure to those skilled in the art. Therefore, the shapes and sizes of elements in the drawings may be exaggerated for clearer explanation, and elements indicated by the same symbols in the drawings are the same elements.

In addition, to clearly explain the present disclosure in the drawings, parts that are not related to the explanation are omitted, and the size and thickness of each component illustrated in the drawings are arbitrarily indicated for the convenience of explanation, so the present disclosure is not necessarily limited to what is illustrated. In addition, components with the same functions within the scope of the same idea are described using the same reference symbols. Furthermore, throughout the specification, when a part is said to “include” a component, this does not mean excluding other components, but rather including other components, unless otherwise specifically stated.

In the drawings, the X-direction may be defined as the direction in which the first and second internal electrodes are alternately disposed with the dielectric layer therebetween, or the first direction, and among the Y-direction and the Z-direction which are directions perpendicular to the X-direction, the Y-direction may be defined as the second direction and the Z-direction may be defined as the third direction.

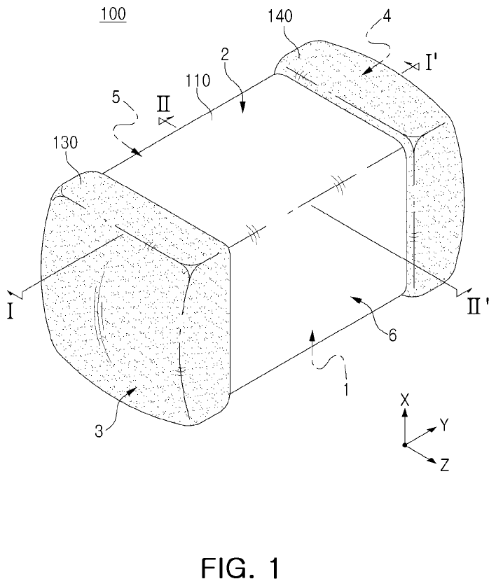

FIG. 1 is a schematic perspective view of a ceramic electronic component according to an embodiment.

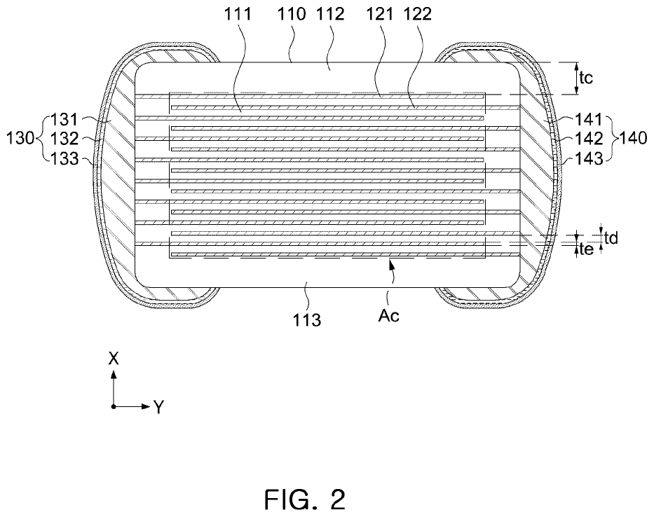

FIG. 2 is a schematic view of a cross-sectional view taken along line I-I′ of FIG. 1.

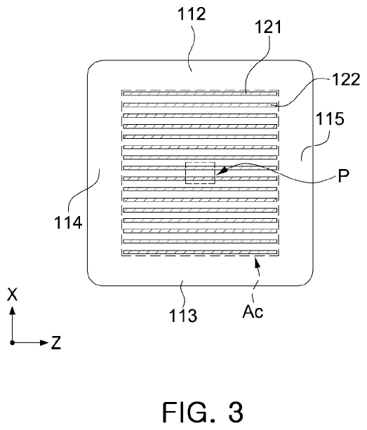

FIG. 3 is a schematic view of a cross-sectional view taken along line II-II′ of FIG. 1.

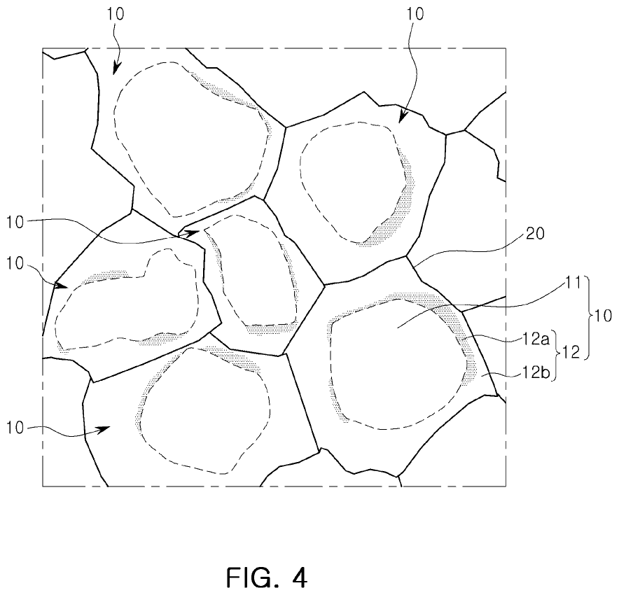

FIG. 4 is a schematic view of dielectric grains and grain boundaries according to an embodiment.

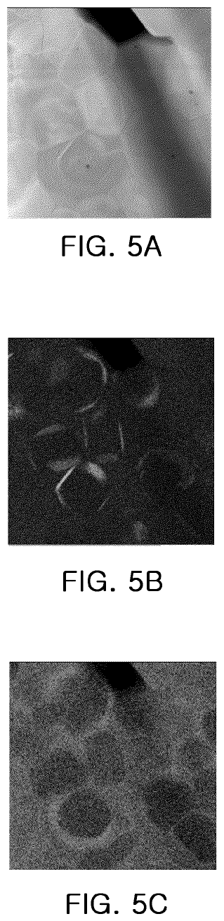

FIGS. 5A, 5B, and 5C are images of the core-shell structure of dielectric grains analyzed by TEM-EDX.

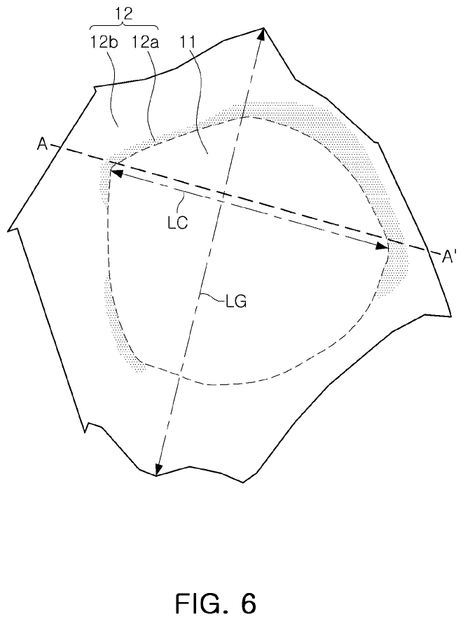

FIG. 6 is a schematic view of the structure of dielectric grains according to an embodiment.

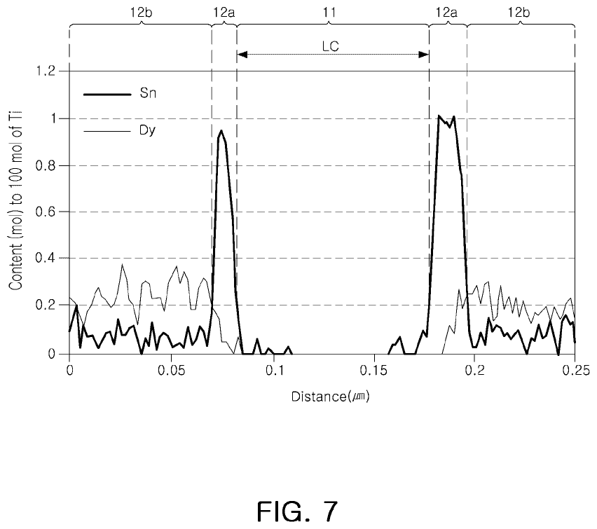

FIG. 7 is a graph illustrating the results of line-profile analysis of the contents of Sn and Dy, taken along line A-A′ of FIG. 6.

Hereinafter, with reference to FIGS. 1 to 4, 5A, 5B, 5C, 6 and 7, a ceramic electronic component 100 according to an embodiment and various embodiments thereof will be described in detail.

A ceramic electronic component 100 according to an embodiment includes a body 110 including a dielectric layer 111 containing a plurality of dielectric grains 10, and internal electrodes 121 and 122, and external electrodes 130 and 140 disposed on the body 110 and connected to the internal electrodes 121 and 122. At least one of the plurality of dielectric grains 10 includes titanium (Ti), tin (Sn), and dysprosium (Dy), and includes a core 11 and a shell 12 surrounding at least a portion of the core 11. The core 11 has a tin (Sn) content of less than 0.2 mol with respect to 100 mol of titanium (Ti) and a dysprosium (Dy) content of less than 0.1 mol with respect to 100 mol of titanium (Ti). The shell 12 includes a first region 12a in which the number of moles of tin (Sn) with respect to 100 mol of titanium (Ti) is greater than the number of moles of dysprosium (Dy) with respect to 100 mol of titanium (Ti), and a second region 12b in which the number of moles of dysprosium (Dy) with respect to 100 mol of titanium (Ti) is greater than the number of moles of tin (Sn) with respect to 100 mol of titanium (Ti). When the maximum Feret diameter of dielectric grains 10 including the core 11 and the shell 12 is LG and the maximum Feret diameter of the core 11 is LC, LC/LG may be in a range from 0.49 to 0.73.

The body 110 may include a dielectric layer 111 and internal electrodes 121 and 122. The dielectric layer 111 and internal electrodes 121 and 122 may be alternately disposed within the body 110, and the direction in which the internal electrodes 121 and 122 and the dielectric layer 111 are alternately disposed may be defined as a stacking direction or a first direction.

There is no particular limitation on the detailed shape of the body 110, but as illustrated in FIG. 1, the body 110 may be formed in a hexahedral shape or a shape similar thereto. In addition, the shape of the body 110 may not be a hexahedral shape with perfectly straight edges due to shrinkage during the sintering process or a separate polishing process, but may substantially have a hexahedral shape.

The body 110 may have first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first and second surfaces 1 and 2, connected to the third and fourth surfaces 3 and 4 and opposing each other in the third direction. The plurality of dielectric layers 111 forming the body 110 are in a sintered state, and the boundary between adjacent dielectric layers 111 may be integrated to the extent that it is difficult to confirm without using a scanning electron microscope (SEM).

As illustrated in FIG. 4, the dielectric layer 111 may include a plurality of dielectric grains 10. In addition, a grain boundary 20 may be disposed between the plurality of dielectric grains 10.

Meanwhile, at least one of the plurality of dielectric grains 10 may include a core 11 and a shell 12 surrounding at least a portion of the core, and the shell 12 may be divided into a first region 12a and a second region 12b according to the content of tin (Sn) and dysprosium (Dy).

Referring to FIG. 5A, it may be confirmed that the dielectric layer is composed of dielectric grains and grain boundaries, and referring to FIG. 5B illustrating the content distribution of tin (Sn) and FIG. 5C illustrating the content distribution of dysprosium (Dy), it may be confirmed that the shell according to an embodiment of the present disclosure includes a region in which the content of tin (Sn) is concentrated.

Referring to FIG. 6, a shell 12 according to an embodiment surrounds at least a portion of a core 11, and the shell 12 may include a first region 12a and a second region 12b.

Referring to FIG. 7, the core 11 may be a region that simultaneously satisfies a condition in which the content of tin (Sn) is less than 0.2 mol relative to 100 mol of titanium (Ti), and a condition in which the content of dysprosium (Dy) is less than 0.1 mol relative to 100 mol of titanium (Ti).

Referring to FIG. 7, the shell 12 may be a region located outside the core 11 in the dielectric grains 10, and the region in which the number of moles of tin (Sn) with respect to 100 moles of titanium (Ti) is greater than the number of moles of dysprosium (Dy) with respect to 100 moles of titanium (Ti) may be a first region 12a, and the region in which the number of moles of dysprosium (Dy) with respect to 100 moles of titanium (Ti) is greater than the number of moles of tin (Sn) with respect to 100 moles of titanium (Ti) may be a second region 12b.

The dielectric layer 111 or at least one of the plurality of dielectric grains 10 included in the dielectric layer 111 may include titanium (Ti). The titanium (Ti) included in at least one of the plurality of dielectric grains 10 may be a component derived from titanium (Ti) included in the barium titanate-based material forming the dielectric layer 111.

The main component of the dielectric composition forming the dielectric layer 111 is not particularly limited as long as sufficient electrostatic capacitance may be obtained. For example, a barium titanate-based material, a lead composite perovskite-based material, a strontium titanate-based material, or the like may be used. The barium titanate-based material may include BaTiO₃-based ceramic powder, and examples of the ceramic powder may include BaTiO₃, (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1) or Ba(Ti_{1-y}Zr_{y})O₃ (0<y<1) in which calcium (Ca), zirconium (Zr), or the like is partially dissolved in BaTiO₃, and the like.

The dielectric layer 111 may include various additives in addition to the barium titanate-based main-component containing titanium (Ti). In an embodiment, to implement the core-shell structure of the dielectric grains 10, the dielectric layer 111 may further include tin (Sn) and dysprosium (Dy) in addition to titanium (Ti), and similarly, at least one of the plurality of dielectric grains 10 may further include tin (Sn) and dysprosium (Dy) in addition to titanium (Ti).

Meanwhile, the average thickness (td) of the dielectric layer 111 does not need to be particularly limited.

For example, to miniaturize the ceramic electronic component 100 and increase the capacitance of the ceramic electronic component 100, the average thickness (td) of the dielectric layer 111 may be 0.35 μm or less, and to secure the reliability of the ceramic electronic component 100 under high temperature and high voltage, the average thickness (td) of the dielectric layer 111 may be 3.0 μm or more.

In an embodiment, the average thickness (td) of the dielectric layer 111 may refer to the average thickness of at least one or more dielectric layers among a plurality of dielectric layers.

The average thickness (td) of the dielectric layer 111 may be measured by scanning an image of the first and third-direction cross section the body 110 using scanning electron microscope (SEM). For example, the average thickness (td) of the dielectric layer 111 may be a value obtained by scanning and obtaining an image of the length and thickness-direction (L-T) cross-section cut from the center of the width direction of the body 110 using a scanning electron microscope (SEM), and averaging the thicknesses measured at a ¼ point, a 2/4 point, and a 3/4 point, provided by dividing the dielectric layer into four parts in the longitudinal direction, based on the dielectric layer of one layer adjacent to the point at which the longitudinal center line and the thickness direction center line of the capacitance forming portion meet in the obtained image. If this measurement is extended to the upper two and lower two dielectric layers having equal intervals based on the dielectric layer of one layer adjacent to the point at which the longitudinal center line and the thickness direction center line of the capacitance forming portion meet, the average thickness of the dielectric layer may be further generalized.

The body 110 may include a capacitance forming portion (Ac) which is disposed inside the body 110 and in which capacitance is formed by including a first internal electrode 121 and a second internal electrode 122 facing each other with the dielectric layer 111 interposed therebetween.

In addition, the capacitance forming portion (Ac) is a portion that contributes to the capacitance formation of the capacitor, and may be formed by repeatedly stacking a plurality of first and second internal electrodes 121 and 122 with the dielectric layer 111 interposed therebetween.

Referring to FIG. 2, cover portions 112 and 113 may be disposed on one surface and the other surface of the capacitance forming portion (Ac) in the first direction. The cover portions 112 and 113 may be formed by stacking a single dielectric layer or two or more dielectric layers on the upper and lower surfaces of the capacitance forming portion (Ac), respectively, in the thickness direction, and may basically play a role in preventing damage to the internal electrode due to physical or chemical stress.

The cover portions 112 and 113 does not include the internal electrode and may include the same material as a material of the dielectric layer 111. For example, the cover portions 112 and 113 may include a ceramic material, and may include, for example, the same ceramic material as the dielectric layer 111.

The average thickness (tc) of the cover portions 112 and 113 need not be particularly limited. However, to more easily obtain miniaturization and high capacitance of the ceramic electronic component, the average thickness (tc) of the cover portions 112 and 113 may be 15 μm or less.

The average thickness (tc) of the cover portions 112 and 113 may refer to the size thereof in the first direction, and may be an average value of the first-direction size of the cover portions 112 and 113 measured at five equally spaced points above or below the capacitance forming portion (Ac).

Referring to FIG. 3, margin portions 114 and 115 may be disposed on one surface and the other surface of the capacitance forming portion (Ac) in the third direction.

The margin portions 114 and 115 include a margin portion 114 disposed on the fifth surface 5 of the body 110 and a margin portion 115 disposed on the sixth surface 6. For example, the margin portions 114 and 115 may be disposed on both side surfaces of the ceramic body 110 in the width direction.

As illustrated in FIG. 3, the margin portions 114 and 115 may refer to regions between both ends of the first and second internal electrodes 121 and 122 and the boundary surface of the body 110 in a cross-section of the body 110 cut in the width-thickness (W-T) direction.

The margin portions 114 and 115 may basically play a role in preventing damage to the internal electrode due to physical or chemical stress.

The margin portions 114 and 115 may be formed by forming the internal electrode by applying a conductive paste on the ceramic green sheet, except for the area in which the margin portion is to be formed.

In some embodiments, to suppress a step caused by the internal electrodes 121 and 122, the internal electrodes may be cut so that they are exposed to the fifth and sixth surfaces 5 and 6 of the body after stacking, and then a single dielectric layer or two or more dielectric layers may be stacked on both side surfaces of the capacitance forming portion (Ac) in the width direction to form the margin portions 114 and 115.

Meanwhile, the width of the margin portions 114 and 115 does not need to be particularly limited. However, to more easily obtain miniaturization and high capacitance of the ceramic electronic component, the average width of the margin portions 114 and 115 may be 15 μm or less.

The average width of the margin portions 114 and 115 may refer to the average size of the margin portions 114 and 115 in the third direction, and may be an average value of the size of the margin portions 114 and 115 in the third direction measured at five equally spaced points on the side surface of the capacitance forming portion (Ac).

The internal electrodes 121 and 122 may be included in the body 110 together with the dielectric layer 111.

The internal electrodes 121 and 122 may include first and second internal electrodes 121 and 122, and the first and second internal electrodes 121 and 122 may be alternately disposed to face each other with the dielectric layer 111 forming the body 110 and interposed therebetween, and may be exposed to the third and fourth surfaces 3 and 4 of the body 110, respectively.

Referring to FIGS. 1 and 2, the first internal electrode 121 may be spaced apart from the fourth surface 4 and exposed through the third surface 3, and the second internal electrode 122 may be spaced apart from the third surface 3 and exposed through the fourth surface 4.

At this time, the first and second internal electrodes 121 and 122 may be electrically separated from each other by a dielectric layer 111 disposed therebetween.

The material forming the internal electrodes 121 and 122 is not particularly limited, and a material having excellent electrical conductivity may be used. For example, the internal electrodes 121 and 122 may include at least one of nickel (Ni), copper (Cu), palladium (Pd), silver (Ag), gold (Au), platinum (Pt), tin (Sn), tungsten (W), titanium (Ti), and alloys thereof.

Meanwhile, there is no need to specifically limit the average thickness (the) of the internal electrodes 121 and 122.

For example, to miniaturize the ceramic electronic component 100 and increase the capacitance thereof, the average thickness (the) of the internal electrodes 121 and 122 may be 0.35 μm or less, and to secure the reliability of the ceramic electronic component 100 under high temperature and high voltage, the average thickness (the) of the internal electrodes 121 and 122 may be 3.0 μm or more.

The average thickness (the) of the internal electrodes 121 and 122 may refer to the average thickness of at least one or more internal electrodes among the plurality of internal electrodes 121 and 122.

The average thickness (the) of the internal electrodes 121 and 122 may be measured by scanning the image of the first and third-direction cross-section of the body 110 using a scanning electron microscope (SEM). For example, the average thickness (the) of the internal electrodes 121 and 122 may be a value obtained by averaging the thicknesses measured at a ¼ point, a 2/4 point, and a 3/4 point when dividing the internal electrode into four parts in the longitudinal direction, based on the internal electrode of one layer adjacent to the point at which the longitudinal center line and the thickness direction center line of the capacitance forming portion of the internal electrode meet, in the image of the length and thickness-direction cross-section cut from the center of the width direction of the body 110 scanned using a scanning electron microscope (SEM). If this measurement is extended to the upper two and lower two internal electrodes having equal spacing based on the internal electrode of one layer adjacent to the point at which the longitudinal center line and the thickness direction center line of the capacitance forming portion meet, the average thickness of the internal electrode may be further generalized.

Referring to FIG. 1, external electrodes 130 and 140 may be disposed on the body 110.

Referring to FIG. 1 and FIG. 2, the external electrodes 130 and 140 may include a first external electrode 130 in contact with the third surface 3 of the body 110 and a second external electrode 140 in contact with the fourth surface 4.

In this embodiment, a structure in which a ceramic electronic component 100 has two external electrodes 130 and 140 is described, but the number or shape of the external electrodes 130 and 140 may be changed depending on the shape of the internal electrodes 121 and 122 or other purposes.

Meanwhile, the external electrodes 130 and 140 may be formed using any material that has electrical conductivity, such as metal, and the detailed material may be determined by considering electrical characteristics, structural stability, or the like, and further, may have a multilayer structure.

For example, the external electrodes 130 and 140 may include electrode layers 131 and 141 disposed on the body 110 and plating layers 132, 133, 142 and 143 formed on the electrode layers 131 and 141.

For a more detailed example of the electrode layers 131 and 141, the electrode layer may be a sintered electrode including a conductive metal and glass, or a resin-based electrode including a conductive metal and resin.

In addition, the electrode layers 131 and 141 may be in a form in which a sintered electrode and a resin-based electrode are sequentially formed on the body. In addition, the electrode layer may be formed by transferring a sheet including a conductive metal onto the body, or may be formed by transferring a sheet including a conductive metal onto the sintered electrode.

A material having excellent electrical conductivity may be used as the conductive metal included in the electrode layers 131 and 141, and is not particularly limited. For example, the conductive metal may be at least one of nickel (Ni), copper (Cu), and alloys thereof, and may preferably be copper (Cu) to improve adhesion to the body.

The plating layers 132, 133, 142 and 143 play a role in improving mounting characteristics. The type of the plating layers 132, 133, 142 and 143 is not particularly limited, and may be a plating layer including at least one of Ni, Sn, Pd, and alloys thereof, and may be formed of multiple layers.

For more detailed examples of the plating layers 132, 133, 142 and 143, the plating layers may be Ni plating layers or Sn plating layers, and may be formed in a form in which Ni plating layers 132 and 142 and Sn plating layers 133 and 143 are sequentially formed on the electrode layers 131 and 141, or in a form in which the Sn plating layer, the Ni plating layer, and the Sn plating layer are sequentially formed. In addition, the plating layers may include a plurality of Ni plating layers and/or a plurality of Sn plating layers.

The core-shell structure of dielectric grains may be divided into a core that secures a permittivity and a shell that secures an insulating property. Therefore, when the structure of the core and shell is appropriately controlled, the capacitance and reliability of the ceramic electronic component may be secured at the same time.

In detail, in the case of patent document 1, a method of simultaneously securing high permittivity and high reliability by ensuring that at least one of the dielectric grains has a core-double shell structure is proposed, but it may be difficult to secure the TCC characteristics and DC-bias characteristics of the ceramic electronic component with only the structure proposed in patent document 1.

On the other hand, when the ceramic electronic component is miniaturized and has high capacitance or is operated under high temperature and high voltage, it may be important to secure not only the permittivity and reliability but also the TCC characteristics and DC-bias characteristics. Accordingly, in the present disclosure, at least one of a plurality of dielectric grains 10 includes a core 11 and a shell 12 surrounding at least a portion of the core 11, and the shell 12 includes a first region 12a in which the content of tin (Sn) is greater than a content of dysprosium (Dy), and a second region 12b in which the content of dysprosium (Dy) is greater than the content of tin (Sn). By controlling the proportion of the core in the dielectric grain, TCC characteristics and DC-bias characteristics may be secured, and deterioration of permittivity and reliability may be alleviated.

In detail, according to an embodiment, the core 11 may refer to a region in which the content of tin (Sn) is less than 0.2 mol with respect to 100 mol of titanium (Ti) and the content of dysprosium (Dy) is less than 0.1 mol with respect to 100 mol of titanium (Ti), and the shell 12 may be a region in the dielectric grains 10 excluding the core 11. The shell 12 may be disposed in a form that surrounds at least a portion of the core 11, and may include a first region 12a in which the number of moles of tin (Sn) with respect to 100 mol of titanium (Ti) is greater than the number of moles of dysprosium (Dy) with respect to 100 mol of titanium (Ti), and a second region 12b in which the number of moles of dysprosium (Dy) with respect to 100 mol of titanium (Ti) is greater than the number of moles of tin (Sn) with respect to 100 mol of titanium (Ti).

When the dielectric grains 10 have a core-shell structure, to improve the TCC characteristics and DC-bias characteristics, it is necessary to form the core 11 to occupy the largest proportion in the dielectric grains 10 as possible. However, if the proportion of the core 11 is increased in a general core-shell structure, the size of the dielectric grains 10 themselves may increase excessively, or the shell 12 may not be sufficiently formed, which may reduce the beneficial effects of increased insulation resistance and suppression of movement of oxygen vacancies by the shell 12.

On the other hand, when Sn is substituted for the Ti site of the shell, the potential barrier is strengthened due to the increase in surface energy of the core-shell interface, and the effect of increasing the resistance of the shell may be expected. Accordingly, in the present disclosure, by disposing the first region 12a where Sn is concentrated, between the core 11 and the second region 12b of the shell 12, the proportion of the core 11 in the dielectric grains 10 may be sufficiently increased to improve the TCC characteristics and DC-bias characteristics, and problems that may occur when the proportion of the core in the dielectric grains is increased in a general core-shell structure may also be alleviated or suppressed.

In an embodiment of the present disclosure, the proportion of the core 11 in the dielectric grains 10 may be expressed as the ratio (LC/LG) of the maximum Feret diameter (LC) of the core to the maximum Feret diameter (LG) of the dielectric grains 10 including the core 11 and the shell 12.

If LC/LG is less than 0.49, the dielectric characteristic (X6S) in which a change in capacitance at −55° C. to 105° C. is within +22% may not be satisfied, and the DC-bias characteristic may be degraded. Therefore, in the present disclosure, by adjusting LC/LG to 0.49 or more, the X6S characteristic may be satisfied, and sufficient DC-bias characteristics may be secured.

The upper limit value of LC/LG is not particularly limited. However, if LC/LG exceeds 0.73, reliability may be degraded when forming a thin dielectric layer 111.

Therefore, in an embodiment, by adjusting LC/LG to be in a range from 0.49 to 0.73, the permittivity may be improved, the reliability of the ceramic c electronic component may be improved, and simultaneously, the X6S characteristic and sufficient DC-bias characteristics may be secured.

Meanwhile, if LC/LG exceeds 0.64, the Mean Time To Failure (MTTF) may be reduced even if the content of the auxiliary component that may be included in the dielectric layer 111 is adjusted. Therefore, in more detail, LC/LG may be in a range from 0.49 to 0.64.

As illustrated in FIG. 6, the maximum Feret diameter may refer to the maximum distance between two points measured on the outer line of the dielectric grain 10 or the core 11. The maximum Feret diameter may be measured by extracting the outer line of dielectric grains 10 and the outer line of core 11 through image analysis software such as Image, and then selecting the greatest value among the values of diameters thereof measured from the distance between two points of the outer line.

Meanwhile, the outer line of dielectric grains 10 or core 11 may be determined by processing a TEM image or TEM-EDS mapping image observed at a magnification of 225,000 times in the central part of the capacitance forming portion (Ac) in the first and second-direction cross section polished to the third-direction center of the ceramic electronic component 100, using image analysis software.

In detail, the outer line of dielectric grains 10 may be determined as a grain boundary 20, which is a dark part in the TEM image, or as a boundary line of an area in which the directions of the crystal structures are different through diffraction pattern analysis. Meanwhile, the outer line of the core 11 may be determined as the boundary of the region that simultaneously satisfies the conditions that the content of tin (Sn) is less than 0.2 mol with respect to 100 mol of titanium (Ti) and the content of dysprosium (Dy) is less than 0.1 mol with respect to 100 mol of titanium (Ti), by overlapping the image in which the tin (Sn) element is mapped and the image in which the dysprosium (Dy) element is mapped after TEM-EDS analysis.

After the boundary of the dielectric grains 10 and the cores 11 is determined, the maximum Feret diameter (LG) of the dielectric grains 10 including the core 11 and the shell 12 may be measured as the length of the line segment having the maximum length among the line segments connecting the two points of the boundary of the dielectric grains 10, and the maximum Feret diameter (LC) of the core 11 may be measured as the length of the line segment having the maximum length among the line segments connecting the two points of the boundary of the core 11. This measurement may be repeated on 10 or more dielectric grains including the core 11 and the shell 12 including the first region 12a and the second region 12b, and may be further generalized by taking the average value of these measurement values.

Meanwhile, the maximum Feret diameter (LC) of the core 11 may be measured more clearly by performing a line-profile analysis along the line segment with the maximum distance among the line segments connecting two points of the outer line of the core 11, and then measuring the length of the region that simultaneously satisfies the conditions that the tin (Sn) content is less than 0.2 mol with respect to 100 mol of titanium (Ti) and the dysprosium (Dy) content is less than 0.1 mol with respect to 100 mol of titanium (Ti).

In an embodiment, the proportion of the core 11 in the dielectric grains 10 may also be expressed as a correlation between the area of the core 11, the area of the first region 12a, and the area of the second region 12b.

In detail, in an embodiment, the area of the core 11 may be larger than the area of the first region 12a, and the area of the second region 12b may be larger than the area of the first region 12a. Accordingly, by maintaining the proportion of the core 11 in the dielectric grains 10 to a relatively large extent, the effect of improving the TCC characteristics and the DC-bias characteristics may be more significant. For the same reason, in an embodiment, the area of the core 11 may be larger than the sum of the areas of the first region 12a and the second region 12b.

The areas of the core 11, first region 12a, and second region 12b are analyzed by TEM-EDS to map the tin (Sn) element and the dysprosium (Dy) element, and then the region satisfying the conditions that the tin (Sn) content is less than 0.2 mol with respect to 100 mol of titanium (Ti) and the dysprosium (Dy) content is less than 0.1 mol with respect to 100 mol of titanium (Ti) is designated as the core 11, the region in which the number of moles of tin (Sn) with respect to 100 mol of titanium (Ti) is greater than the number of moles of dysprosium (Dy) with respect to 100 mol of titanium (Ti) is designated as the first region 12a, and the region in which the number of moles of dysprosium (Dy) with respect to 100 mol of titanium (Ti) is greater than the number of moles of tin (Sn) with respect to 100 mol of titanium (Ti) is designated as the second region 12b. Then, the regions are designated as pixels using the ImageJ program to calculate the area of each region, thereby performing the measurement.

The tin (Sn) content in the first region 12a may be 0.2 mol or more and 4.5 mol or less with respect to 100 mol of titanium (Ti). Accordingly, the phenomenon of elements included in the second region 12b described later diffusing into the core 11 may be prevented. In addition, the peak value of the tin (Sn) content may be formed within the first region 12a in the entire dielectric grains 10, and the peak value of the tin (Sn) content may be formed within the range of 0.2 mol or more and 4.5 mol or less with respect to 100 mol of titanium (Ti).

The average content of tin (Sn) with respect to 100 mol of titanium (Ti) in the first region 12a may be twice or more the average content of tin (Sn) with respect to 100 mol titanium of (Ti) in the second region 12b. By concentrating tin (Sn) in the first region 12a adjacent to the core 11, the decrease in reliability that may occur as the size of the core 11 increases may be alleviated.

By concentrating tin (Sn) in the first region 12a adjacent to the core 11, when the average content of tin (Sn) with respect to 100 moles of titanium (Ti) in the core 11 is Sc, the average content of tin (Sn) with respect to 100 moles of titanium (Ti) in the first region 12a is S1, and the average content of tin (Sn) with respect to 100 moles of titanium (Ti) in the second region 12b is S2, S1>S2>Sc may be satisfied.

Dysprosium (Dy) of the dielectric layer 111 plays a role in improving the insulating properties, but when excessively diffused or substituted into the core 11, the permittivity may be lowered. Therefore, in an embodiment, the content of dysprosium (Dy) may have a maximum value in the second region 12b, and the average content of dysprosium (Dy) may be the largest in the second region 12b. For example, when the average content of dysprosium (Dy) relative to 100 moles of titanium (Ti) in the core 11 is Dc, the average content of dysprosium (Dy) relative to 100 moles of titanium (Ti) in the first region 12a is D1, and the average content of dysprosium (Dy) relative to 100 moles of titanium (Ti) in the second region 12b is D2, D2>D1>Dc may be satisfied.

In an embodiment, Dc and D1 may be 0.04 moles or less relative to 100 moles of titanium (Ti), respectively, and thus, the problem of excessive diffusion or substitution of dysprosium (Dy) into the core 11 and a decrease in permittivity thereby may be suppressed.

In an embodiment, the dielectric layer 111 may further include at least one additional rare earth element other than dysprosium (Dy). For example, the dielectric layer 111 may include dysprosium (Dy) and at least one of rare earth elements other than dysprosium (Dy). Accordingly, a reliability degradation problem that may occur in the case in which the dielectric layer 111 includes only dysprosium (Dy) as a rare earth element may be suppressed.

When the average content of rare earth elements including dysprosium (Dy) with respect to 100 moles of titanium (Ti) in the core 11 is Rec, the average content of rare earth elements including dysprosium (Dy) with respect to 100 moles of titanium (Ti) in the first region 12a is Re1, and the average content of rare earth elements including dysprosium (Dy) with respect to 100 moles of titanium (Ti) in the second region 12b is Re2, Re2>Re1>Rc may be satisfied.

Examples of rare earth elements other than dysprosium (Dy) include lanthanum (La), yttrium (Y), actinium (Ac), cerium (Ce), praseodymium (Pr), neodymium (Nd), promethium (Pm), samarium (Sm), europium (Eu), gadolinium (Gd), terbium (Tb), holmium (Ho), erbium (Er), thulium (Tm), ytterbium (Yb), lutetium (Lu), and the like.

The dielectric layer 111 may include a fixed-valence element. There is no need to specifically limit the type of the fixed-valence element, and in an embodiment, the dielectric layer 111 may include vanadium (V) as the fixed-valence element. At this time, when the number of moles of rare earth elements with respect to 100 moles of titanium (Ti) in the dielectric layer 111 is Ret, and the number of moles of vanadium (V) with respect to 100 moles of titanium (Ti) is Vt, Vt/Ret may be greater than 0.056 and less than 0.222. If Vt/Ret is 0.056 or less, it may be difficult to secure TCC characteristics and reliability, and if Vt/Ret is 0.222 or more, the permittivity may be lowered or the DC-bias characteristics may be lowered.

A portion of tin (Sn) included in the dielectric layer 111 may diffuse toward the internal electrodes 121 and 122 during the sintering process. Therefore, the internal electrodes 121 and 122 may further include tin (Sn) in addition to nickel (Ni).

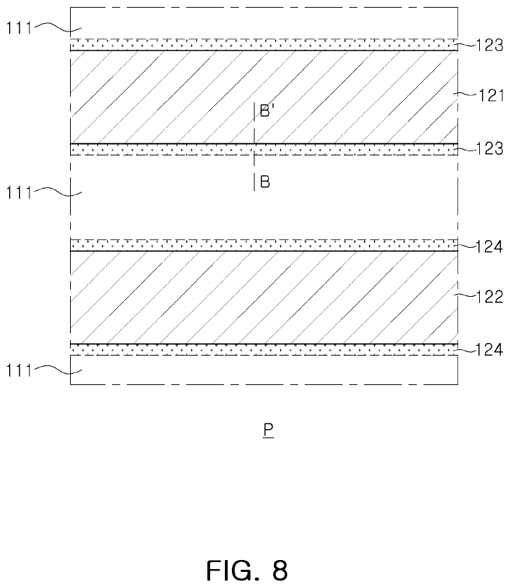

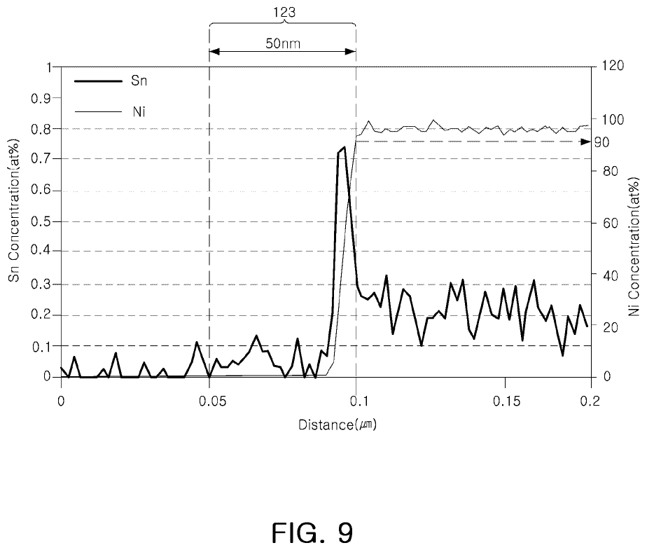

Referring to FIG. 8, interface portions 123 and 124 may be disposed between the internal electrodes 121 and 122 and the dielectric layer 111. The interface portions 123 and 124 may be formed by suppressing the diffusion of tin (Sn) included in the dielectric layer 111 by a high concentration of nickel (Ni). Accordingly, the interface portions 123 and 124 may form a peak value having a maximum tin (Sn) content as illustrated in FIG. 9. The range of the peak value of the tin (Sn) content is not particularly limited, but when the tin (Sn) content is 0.55 mol or more relative to 100 mol of nickel (Ni), the capacitance improvement effect according to an embodiment of the present disclosure, the capacitance change characteristics according to temperature, and the effects of improving high-temperature reliability may be more significant.

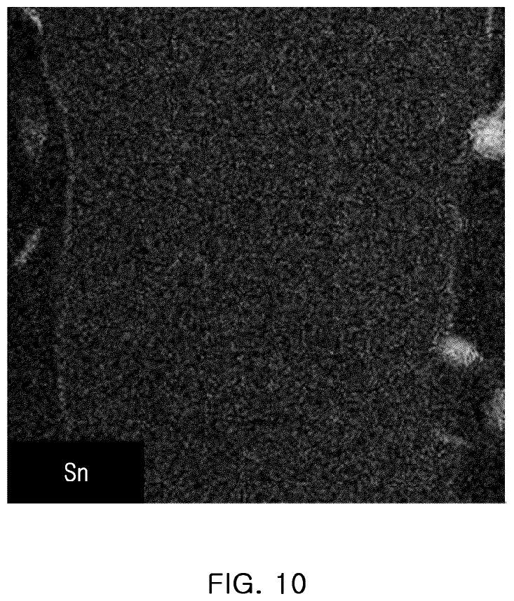

Meanwhile, referring to FIG. 10, it may be confirmed that there is a region in which the tin (Sn) content is measured high in the interface region between the dielectric layer and the internal electrode, and in an embodiment, this region is defined as the interface portions 123 and 124.

Referring to FIG. 9, the interface portion may refer to a region that is from the point at which the nickel (Ni) content relative to a content of all elements excluding oxygen (O) in the internal electrode begins to decrease to 90 at % or less, to 50 nm in an inward direction of the dielectric layer. Accordingly, the internal electrodes 121 and 122 may be a region in which the nickel (Ni) content exceeds 90 at % compared to all elements excluding oxygen (O).

Referring to FIG. 9, the peak value of the tin (Sn) content in the interface portions 123 and 124 may be formed to be biased toward the internal electrodes 121 and 122. The capacitance improvement effect, the capacitance change characteristic according to temperature, and the effect of improving high-temperature reliability according to an embodiment of the present disclosure may be more significant.

Referring to FIG. 9, when the average content of tin (Sn) compared to the content of all elements excluding oxygen (O) in the internal electrodes 121 and 122 is S1, and the average content of tin (Sn) compared to the content of all elements excluding oxygen (O) in the dielectric layer is S2, S1>S2 may be satisfied. Accordingly, the shrinkage of the internal electrodes 121 and 122 occurring during the sintering process may be delayed, thereby improving the connectivity of the internal electrodes 121 and 122.

### Experimental Example

BaTiO₃ particles corresponding to the core 11 were synthesized using a hydrothermal synthesis method. In this process, the particle size of BaTiO₃ was synthesized in various sizes considering the size of the core 11 in the final product. After that, SnO₂ was added to form the region that is to become the first region 12a of the shell, and the oxide (Re₂O₃) of a rare earth element is added as the first auxiliary component, and in some cases, terbium oxide (Tb₄O₇) was added, and vanadium oxide (V₂O₃) is added as the second auxiliary component to form grain growth, thereby forming the region that is to become the second region 12b of the shell. Then, the dielectric powder was mixed with a dispersant using ethanol and toluene as solvents, and then a binder was mixed to produce a ceramic sheet. Ni electrodes were printed on the formed ceramic sheet and laminated, and the pressed and cut chips were sintered for binder removal and then fired to produce a sample chip.

At this time, the maximum Feret diameter (LC) of the core 11 and the maximum Feret diameter (LG) of the entire dielectric grains 10 may vary depending on the size of the initial BaTiO₃ particles that will form the core 11 and the size of the final dielectric grains according to the grain growth rate.

Table 1 below shows the maximum Feret diameter (LC) of the core 11, the maximum Feret diameter (LG) of the entire dielectric grains 10, whether the first region 12a and the second region 12b of the shell are distinguished, and the content of each auxiliary component, according to respective test numbers. Table 2 shows the room temperature permittivity and dissipation factor (DF), the change in capacitance according to temperature, Mean Time To Failure (MTTF), and DC-bias characteristics of the final ceramic electronic component including the dielectric layer satisfying the conditions of Table 1.

The room temperature permittivity and dissipation factor (DF) were measured using an LCR meter at 1 kHz and AC 0.5 V. The permittivity of the MLCC chip dielectric was calculated from the capacitance, the dielectric thickness of the MLCC chip, the internal electrode area, and the number of stacked layers. DC effective capacitance was measured by taking 10 (ten) samples at a time, applying DC 3 V, and then taking the average value after 60 seconds.

The change in electrostatic capacitance according to temperature was measured under the conditions of 1 kHz, 0.15 V, and 5 min maintenance in the temperature range of −55° C. to 105° C. 10 samples were taken at a time, and measured, and then the average value was taken.

The Mean Time To Failure (MTTF) value was calculated by measuring the time until failure occurred by applying a voltage corresponding to an electric field of 27 V/μm at 125° C. to 10 samples, and creating an average time. When the MTTF was 20.1 h or less, it was evaluated as being defective (X), when it was longer than 20.1 h to 28 h or less, it was evaluated as being fair (Δ), when it was longer than 28 h to 30 h or less, it was evaluated as being good (∘), and when it was longer than 30 h, it was evaluated as being excellent ( [symbol] ).

DC-bias characteristic determination was performed by applying a low voltage and high frequency AC signal to 10 samples using an LCR meter under a 3V DC bias voltage, and measuring the measured capacitance. A case of 0.78 μF or less was evaluated as being defective (X), a case of being longer than 0.78 μF to 0.82 or less was evaluated as being fair (Δ), a case of 0.83 μF or more and less than 0.87 μF was evaluated as being good (∘), and a case of 0.87 μF or more was evaluated as being excellent (⊚).

The final comprehensive characteristic determination was evaluated as defective (X) if it included one or more defects among the individual characteristics of the example, fair (Δ) if it did not include any defects among the individual characteristics of the example but included one or more fair characteristics, and excellent (⊚) if it satisfied all the characteristics of the example as good or better.

TABLE 1

| | | | | | | Number of moles of | | |
|---|---|---|---|---|---|---|---|---|
| | | | | | | Auxiliary Component | | |
| | | | | | | to 100 moles of Ti | | |
| | | | | Shell Area | | First | | Second |
| | | | | Division | | Auxiliary | | Auxiliary |
| Test | LC | LG | LC/ | First | Second | Component | | Component |
| Number | (nm) | (nm) | LG | Region | Region | Tb₄O₇ | Re₂O₃ | V₂O₃ |
| 1 | 150 | 600 | 25% | X | ◯ | 0.3 | 1.2 | 0.1 |
| 2 | 150 | 600 | 25% | X | ◯ | 0.3 | 1.2 | 0.25 |
| 3 | 150 | 600 | 25% | X | ◯ | 0.3 | 1.2 | 0.4 |
| 4 | 150 | 600 | 25% | ◯ | ◯ | 0.3 | 1.2 | 0.1 |
| 5 | 150 | 600 | 25% | ◯ | ◯ | 0.3 | 1.2 | 0.25 |
| 6 | 150 | 600 | 25% | ◯ | ◯ | 0.3 | 1.2 | 0.4 |
| 7 | 150 | 600 | 25% | ◯ | ◯ | 0 | 1.5 | 0.4 |
| 8 | 210 | 430 | 49% | X | ◯ | 0.3 | 1.2 | 0.1 |
| 9 | 210 | 430 | 49% | X | ◯ | 0.3 | 1.2 | 0.25 |
| 10 | 210 | 430 | 49% | X | ◯ | 0.3 | 1.2 | 0.4 |
| 11 | 210 | 430 | 49% | ◯ | ◯ | 0.3 | 1.2 | 0.1 |
| 12 | 210 | 430 | 49% | ◯ | ◯ | 0.3 | 1.2 | 0.25 |
| 13 | 210 | 430 | 49% | ◯ | ◯ | 0.3 | 1.2 | 0.4 |
| 14 | 210 | 430 | 49% | ◯ | ◯ | 0 | 1.5 | 0.4 |
| 15 | 230 | 430 | 53% | X | ◯ | 0.3 | 1.2 | 0.1 |
| 16 | 230 | 430 | 53% | X | ◯ | 0.3 | 1.2 | 0.25 |
| 17 | 230 | 430 | 53% | X | ◯ | 0.3 | 1.2 | 0.4 |
| 18 | 230 | 430 | 53% | ◯ | ◯ | 0.3 | 1.2 | 0.1 |
| 19 | 230 | 430 | 53% | ◯ | ◯ | 0.3 | 1.2 | 0.25 |
| 20 | 230 | 430 | 53% | ◯ | ◯ | 0.3 | 1.2 | 0.4 |
| 21 | 230 | 430 | 53% | ◯ | ◯ | 0 | 1.5 | 0.4 |
| 22 | 290 | 450 | 64% | X | ◯ | 0.3 | 1.2 | 0.1 |
| 23 | 290 | 450 | 64% | X | ◯ | 0.3 | 1.2 | 0.25 |
| 24 | 290 | 450 | 64% | X | ◯ | 0.3 | 1.2 | 0.4 |
| 25 | 290 | 450 | 64% | ◯ | ◯ | 0.3 | 1.2 | 0.1 |
| 26 | 290 | 450 | 64% | ◯ | ◯ | 0.3 | 1.2 | 0.25 |
| 27 | 290 | 450 | 64% | ◯ | ◯ | 0.3 | 1.2 | 0.4 |
| 28 | 230 | 430 | 53% | ◯ | ◯ | 0 | 1.5 | 0.4 |
| 29 | 320 | 440 | 73% | ◯ | ◯ | 0.3 | 1.2 | 0.1 |
| 30 | 320 | 440 | 73% | ◯ | ◯ | 0.3 | 1.2 | 0.25 |
| 31 | 320 | 440 | 73% | ◯ | ◯ | 0.3 | 1.2 | 0.4 |

TABLE 2

| | Chip Characteristics | | | | | | | | | | |
|---|---|---|---|---|---|---|---|---|---|---|---|
| | | | | | | TCC | | | | | Character- |
| | Room | | | | | Character- | | | DC | DC | istics |
| | Temper- | | Permit- | | | istics | | | Effective | Character- | Determi- |
| | ature | | tivity/ | TCC | TCC | Determi- | | MTFF | Capacitance | istics | nation |
| Test | Permit- | | Grain | (−55 | (−105 | nation | MTFF | Determi- | (@3 V | Determi- | (Compre- |
| Number | tivity | DF | Size | degrees) | degrees) | (X6S) | (h) | nation | HFLV) | nation | hensive)) |
| 1 | 3421 | 4.52% | 17.2 | −22.15 | −29.01 | X | 16.5 | X | 0.79 | Δ | X |
| 2 | 3408 | 4.71% | 16.9 | −23.12 | −27.11 | X | 18.2 | X | 0.77 | X | X |
| 3 | 3215 | 4.98% | 16.2 | −23.22 | −24.15 | X | 20.5 | Δ | 0.74 | X | X |
| 4 | 3510 | 4.62% | 17.1 | −20.79 | −34.21 | X | 24.7 | Δ | 0.82 | Δ | X |
| 5 | 3459 | 4.75% | 16.8 | −21.58 | −31.58 | X | 29.6 | ◯ | 0.81 | Δ | X |
| 6 | 3406 | 5.01% | 16.2 | −22.01 | −27.51 | X | 34.8 | ⊚ | 0.77 | X | X |
| 7 | 3415 | 4.89% | 16.3 | −22.15 | −26.96 | X | 20.1 | X | 0.78 | X | X |
| 8 | 3592 | 3.82% | 20.4 | −21.97 | −21.15 | Δ | 12.6 | X | 0.83 | ◯ | X |
| 9 | 3578 | 4.01% | 20.1 | −20.88 | −20.12 | ◯ | 14.2 | X | 0.82 | Δ | X |
| 10 | 3376 | 4.28% | 19.4 | −20.01 | −19.22 | ◯ | 16 | X | 0.79 | Δ | X |
| 11 | 3686 | 3.92% | 20.3 | −21.88 | −21.79 | Δ | 27.1 | Δ | 0.84 | ◯ | X |
| 12 | 3632 | 4.05% | 20 | −21.15 | −20.58 | ◯ | 32.2 | ⊚ | 0.83 | ◯ | ⊚ |
| 13 | 3576 | 4.31% | 19.4 | −20.77 | −21.01 | ◯ | 23.7 | Δ | 0.8 | Δ | Δ |
| 14 | 3586 | 4.19% | 19.5 | −21.15 | −21.15 | ◯ | 20.3 | Δ | 0.8 | Δ | Δ |
| 15 | 3660 | 3.63% | 21.4 | −21.17 | −22.05 | Δ | 11.8 | X | 0.83 | ◯ | X |
| 16 | 3647 | 3.82% | 21.1 | −20.08 | −19.72 | ◯ | 12.9 | X | 0.83 | ◯ | X |
| 17 | 3440 | 4.09% | 20.4 | −19.21 | −18.84 | ◯ | 14.2 | X | 0.79 | Δ | X |
| 18 | 3756 | 3.73% | 21.3 | −21.08 | −22.33 | Δ | 27.3 | Δ | 0.84 | ◯ | Δ |
| 19 | 3701 | 3.86% | 21.3 | −20.35 | −20.17 | ◯ | 31.3 | ⊚ | 0.84 | ◯ | ⊚ |
| 20 | 3644 | 4.12% | 20.4 | −19.97 | −19.65 | ⊚ | 26.4 | Δ | 0.79 | Δ | Δ |
| 21 | 3654 | 4.00% | 20.5 | −20.35 | −18.01 | ⊚ | 16.3 | X | 0.79 | Δ | X |
| 22 | 3729 | 3.56% | 23.1 | −20.11 | −19.71 | ◯ | 9.44 | X | 0.87 | ⊚ | X |
| 23 | 3715 | 3.74% | 22.8 | −19.08 | −18.69 | ◯ | 10.3 | X | 0.87 | ⊚ | X |
| 24 | 3504 | 4.01% | 22.1 | −18.25 | −17.88 | ⊚ | 11.4 | X | 0.83 | ◯ | X |
| 25 | 3843 | 3.66% | 23.3 | −20.03 | −19.63 | ◯ | 24.6 | Δ | 0.88 | ⊚ | X |
| 26 | 3788 | 3.78% | 23 | −19.33 | −18.95 | ◯ | 28.2 | ◯ | 0.88 | ⊚ | ⊚ |
| 27 | 3730 | 4.04% | 22.5 | −18.97 | −18.59 | ⊚ | 20.7 | Δ | 0.83 | ◯ | Δ |
| 28 | 3739 | 3.92% | 22.6 | −19.33 | −18.95 | ⊚ | 14.7 | X | 0.83 | ◯ | X |
| 29 | 3866 | 3.45% | 24.8 | −18.02 | −17.92 | ⊚ | 12.3 | X | 0.95 | ⊚ | X |
| 30 | 3801 | 3.63% | 24.4 | −17.4 | −17.3 | ⊚ | 14.1 | X | 0.92 | ⊚ | X |
| 31 | 3633 | 3.89% | 23.6 | −17.07 | −16.97 | ⊚ | 10.4 | X | 0.87 | ⊚ | X |

Referring to Table 1 and Table 2, in the case of Test No. 8 to Test No. 31 where LC/LG is in a range from 0.49 to 0.73, it can be confirmed that the TCC characteristic is fair (Δ) or higher and the DC characteristic is fair (Δ) or higher regardless of the contents of the first and second auxiliary components, whereas in the case where LC/LG is less than 0.49, both the TCC characteristic and the DC characteristic are defective (X) regardless of the contents of the first and second auxiliary components. In addition, in the case of Test No. 8 to Test No. 31, since the room temperature permittivity exceeds 3300, it can be confirmed that there is no decrease in permittivity.

Therefore, in the case where LC/LG is in a range from 0.49 to 0.73 as in an embodiment, it can be confirmed that the ceramic electronic component 100 may secure excellent permittivity, TCC characteristic, and DC characteristic.

Meanwhile, for test numbers 29 to 31 where LC/LG exceeds 0.64, it can be confirmed that the MTTF is defective (X) regardless of the contents of the first and second auxiliary components. Therefore, according to an embodiment, when LC/LG is in a range from 0.49 to 0.64, the TCC characteristics and DC characteristics may be secured, and the phenomenon in which the reliability is lowered due to the core occupying an excessive proportion of the entire crystal grains may be suppressed.

As set forth above, according to an embodiment, the permittivity of a ceramic electronic component is improved as at least one of a plurality of dielectric grains includes a core and a shell surrounding at least a portion of the core, the shell including a first region in which the number of moles of tin (Sn) with respect to 100 moles of titanium (Ti) is greater than the number of moles of dysprosium (Dy) with respect to 100 moles of titanium (Ti), and a second region in which the number of moles of dysprosium (Dy) with respect to 100 moles of titanium (Ti) is greater than the number of moles of tin (Sn) with respect to 100 moles of titanium (Ti).

According to an embodiment, at least one of a plurality of dielectric grains includes a core and a shell surrounding at least a portion of the core, and the shell includes a first region in which the number of moles of tin (Sn) with respect to 100 moles of titanium (Ti) is greater than the number of moles of dysprosium (Dy) with respect to 100 moles of titanium (Ti), and a second region in which the number of moles of dysprosium (Dy) with respect to 100 moles of titanium (Ti) is greater than the number of moles of tin (Sn) with respect to 100 moles of titanium (Ti), and when a maximum Feret diameter of the dielectric grains including the core and the shell is LG and a maximum Feret diameter of the core is LC, LC/LG satisfies 0.49 or more and 0.73 or less, thereby improving TCC characteristics and DC-bias characteristics of the ceramic electronic component.

Although the embodiments of the present disclosure have been described in detail above, the present disclosure is not limited by the above-described embodiments and the attached drawings, but is intended to be limited by the appended claims. Accordingly, various forms of substitution, modification, and change may be made by those skilled in the art within the scope that does not depart from the technical idea of the present disclosure described in the claims, and this also falls within the scope of the present disclosure.

In addition, the expression ‘an (one) embodiment’ used in the present disclosure does not mean the same embodiment, and is provided to emphasize and explain each unique feature that is different from the other. However, the embodiments presented above do not exclude being implemented in combination with the features of another embodiment. For example, even if a matter described in a specific embodiment is not described in another embodiment, it can be understood as a description related to another embodiment, unless there is a description that is contrary or contradictory to that matter in another embodiment.

The terms used in the present disclosure are used only to describe one embodiment, and are not intended to limit the present disclosure. In this case, the singular expression includes the plural expression unless the context clearly indicates otherwise.

While example embodiments have been illustrated and described above, it will be apparent to those skilled in the art that modifications and variations could be made without departing from the scope of the present disclosure as defined by the appended claims.

What is claimed is:

1. A ceramic electronic component comprising:
a body including a dielectric layer containing a plurality of dielectric grains, and an internal electrode; and
an external electrode disposed on the body and connected to the internal electrode,
wherein at least one of the plurality of dielectric grains includes titanium (Ti), tin (Sn), and dysprosium (Dy), and includes a core and a shell surrounding at least a portion of the core,
the core has a tin (Sn) content of less than 0.2 mol with respect to 100 moles of titanium (Ti) and a dysprosium (Dy) content of less than 0.1 mol with respect to 100 moles of titanium (Ti),
the shell includes a first region in which a number of moles of tin (Sn) with respect to 100 moles of titanium (Ti) is greater than a number of moles of dysprosium (Dy) with respect to 100 moles of titanium (Ti), and a second region in which the number of moles of dysprosium (Dy) with respect to 100 moles of titanium (Ti) is greater than the number of moles of tin (Sn) with respect to 100 moles of titanium (Ti), and
when a maximum Feret diameter of the plurality of dielectric grains including the core and the shell is LG, and a maximum Feret diameter of the core is LC, LC/LG is in a range from 0.49 to 0.73.

2. The ceramic electronic component of claim 1, wherein the internal electrode includes nickel (Ni) and tin (Sn), and
when a region from a point at which a content of nickel (Ni) relative to a content of all elements excluding oxygen (O) in the internal electrode begins to decrease to 90 at % or less, to 50 nm in an inward direction of the dielectric layer is defined as an interface portion, the interface portion has a peak value of tin (Sn) content of 0.55 mol or more relative to 100 moles of nickel (Ni).

3. The ceramic electronic component of claim 1, wherein the internal electrode includes nickel (Ni) and tin (Sn), and
when an average content of tin (Sn) relative to a content of all elements excluding oxygen (O) in the internal electrode is S1, and an average content of tin (Sn) relative to the content of all elements excluding oxygen (O) in the dielectric layer is S2, S1>S2 is satisfied.

4. The ceramic electronic component of claim 1, wherein a content of nickel (Ni) of the internal electrode exceeds 90 at % of all elements excluding oxygen (O).

5. The ceramic electronic component of claim 1, wherein a content of tin (Sn) in the first region is in a range from 0.2 mol to 4.5 mol with respect to 100 moles of titanium (Ti).

6. The ceramic electronic component of claim 1, wherein an average content of tin (Sn) with respect to 100 moles of titanium (Ti) in the first region is at least twice an average content of tin (Sn) with respect to 100 moles of titanium (Ti) in the second region.

7. The ceramic electronic component of claim 1, wherein, when an average content of tin (Sn) with respect to 100 moles of titanium (Ti) in the core is Sc, an average content of tin (Sn) with respect to 100 moles of titanium (Ti) in the first region is S1, and an average content of tin (Sn) with respect to 100 moles of titanium (Ti) in the second region is S2, S1>S2>Sc is satisfied.

8. The ceramic electronic component of claim 1, wherein, when an average content of dysprosium (Dy) with respect to 100 moles of titanium (Ti) in the core is Dc, an average content of dysprosium (Dy) with respect to 100 moles of titanium (Ti) in the first region is D1, and an average content of dysprosium (Dy) with respect to 100 moles of titanium (Ti) in the second region is D2, D2>D1>Dc is satisfied.

9. The ceramic electronic component of claim 8, wherein the Dc and the D1 are each 0.04 mol or less.

10. The ceramic electronic component of claim 1, wherein the dielectric layer further includes at least one additional rare earth element other than dysprosium (Dy),
when an average content of a rare earth element including dysprosium (Dy) relative to 100 moles of titanium (Ti) in the core is Rec, an average content of a rare earth element including dysprosium (Dy) relative to 100 moles of titanium (Ti) in the first region is Re1, and an average content of a rare earth element including dysprosium (Dy) relative to 100 moles of titanium (Ti) in the second region is Re2, Re2>Re1>Rec is satisfied.

11. The ceramic electronic component of claim 10, wherein the additional rare earth element is selected from the group consisting of lanthanum (La), yttrium (Y), actinium (Ac), cerium (Ce), praseodymium (Pr), neodymium (Nd), promethium (Pm), samarium (Sm), europium (Eu), gadolinium (Gd), terbium (Tb), holmium (Ho), erbium (Er), thulium (Tm), ytterbium (Yb), and lutetium (Lu).

12. The ceramic electronic component of claim 1, wherein the dielectric layer includes vanadium (V) as a fixed-valence element, and
when a number of moles of a rare earth element with respect to 100 moles of titanium (Ti) in the dielectric layer is Ret and a number of moles of vanadium (V) with respect to 100 moles of titanium (Ti) is Vt, Vt/Ret is in a range from 0.056 to 0.222.

13. The ceramic electronic component of claim 1, wherein an area of the core is larger than an area of the first region, and an area of the second region is larger than the area of the first region.

14. The ceramic electronic component of claim 1, wherein an area of the core is larger than a sum of an area of the first region and an area of the second region.

15. The ceramic electronic component of claim 1, wherein LC/LG is in a range from 0.49 to 0.64.

16. A ceramic electronic component, comprising:
a dielectric layer including at least one dielectric grain having a core and a shell surrounding at least a portion of the core, the dielectric grains comprising titanium, tin and dysprosium, wherein, for every 100 moles of titanium:
in the core, content of tin is less than 0.2 moles and content of dysprosium is less than 0.1 moles,
in a first region of the shell relatively closer to the core, content of tin is greater than content of dysprosium, and
in a second region of the shell relatively farther from the core, content of tin is smaller than content of dysprosium; and
an internal electrode disposed on the dielectric layer, and comprising nickel and tin, wherein at an interface portion between the internal electrode and the dielectric layer, a peak value of tin content is 0.55 moles or more for every 100 moles of nickel.

17. The ceramic electronic component of claim 16, wherein a ratio of a maximum Feret diameter of the core to a maximum Feret diameter of the dielectric grain is in a range from 0.49 to 0.73.

18. The ceramic electronic component of claim 16, wherein the interface portion defines a region in the internal electrode that is within 50 nm toward the dielectric layer from a point at which nickel content decreases to 90 at % relative to content of all elements in the internal electrode.

19. The ceramic electronic component of claim 16, wherein the content of tin in the first region is in a range from 0.2 moles to 4.5 moles for every 100 moles of titanium.

20. The ceramic electronic component of claim 16, wherein an average content of tin relative to 100 moles of titanium in the first region at least twice that in the second region.

21. The ceramic electronic component of claim 16, wherein an average content of tin relative to 100 moles of titanium in the second region is greater than that in the core.

22. A ceramic electronic component, comprising:
a dielectric layer comprising vanadium as a fixed-valence element and including at least one dielectric grain having a core and a shell surrounding at least a portion of the core, the dielectric grains comprising titanium, tin and dysprosium, wherein, for every 100 moles of titanium:
a ratio of a number of moles of vanadium to a number of moles of rare earth elements in the dielectric layer is in a range from 0.056 to 0.222,
in the core, content of tin is less than 0.2 moles and content of dysprosium is less than 0.1 moles,
in a first region of the shell relatively closer to the core, content of tin is greater than content of dysprosium, and
in a second region of the shell relatively farther from the core, content of tin is smaller than content of dysprosium.

23. The ceramic electronic component of claim 22, wherein a ratio of a maximum Feret diameter of the core to a maximum Feret diameter of the dielectric grain is in a range from 0.49 to 0.64.

24. The ceramic electronic component of claim 22, wherein the dielectric layer further comprises at least one additional rare earth element selected from the group consisting of lanthanum (La), yttrium (Y), actinium (Ac), cerium (Ce), praseodymium (Pr), neodymium (Nd), promethium (Pm), samarium (Sm), europium (Eu), gadolinium (Gd), terbium (Tb), holmium (Ho), erbium (Er), thulium (Tm), ytterbium (Yb), and lutetium (Lu), and
wherein, for every 100 moles of titanium, an average total content of rare earth elements in the core represented as Rec, an average total content of rare earth elements in the first region represented as Re1, and an average total content of rare earth elements in the second region represented as Re2 satisfy Re2>Re1>Rec.
